(19) United States
(12) Patent Application Publication
(10) Pub. No.: US 2016/0245915 A1
(43) Pub. Date: Aug. 25, 2016

(54) Forward and Rear Scanning Sonar

(71) Applicant: Navico Holding AS, Egersund (NO)

(72) Inventor: Jeremiah Clark, Tulsa, OK (US)

(21) Appl. No.: 14/626,497

(22) Filed: Feb. 19, 2015

(51) Int. Cl. G01S 15/96; G01S 15/89; G01S 7/56

(52) U.S. Cl. CPC G01S 15/96; G01S 7/56; G01S 15/89

(57) ABSTRACT

Various implementations described herein are directed to a system having forward and rear scanning sonar. The system may include a fore facing transducer configured to provide forward scanning sonar data below a surface of a body of water and corresponding to a bow of a vessel. The system may include an aft facing transducer configured to provide rear scanning sonar data below the surface of the body of water and corresponding to a stern of the vessel.

### BACKGROUND

This section is intended to provide information to facilitate an understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

When trolling, sonar may be used to locate fish. Typically, an angler's vessel may be equipped with a sonar device looking in only one direction. In these instances, anglers may spend significant time trolling back and forth and searching over possible locations of fish in the water column before blindly setting their lure depth.

### SUMMARY

Described herein are implementations of various technologies for a system having a fore facing transducer configured to provide forward scanning sonar data below a surface of a body of water and corresponding to a bow of a vessel. The system may include an aft facing transducer configured to provide rear scanning sonar data below the surface of the body of water and corresponding to a stern of the vessel.

Described herein are also implementations of various technologies for a system having a plurality of transducers coupled to a vessel. The plurality of transducers may include a first transducer configured to provide fore scanning sonar data relative to a bow of the vessel. The plurality of transducers may include a second transducer configured to provide aft scanning sonar data relative to a stern of the vessel. The system may include a computing device configured to display images associated with the fore scanning sonar data and the aft scanning sonar data on a display.

Described herein are also implementations of various technologies for a multi-function display having a processor, a display, and memory including instructions that cause the processor to perform various actions. The actions may include receiving forward scanning sonar data from a fore sonar transducer coupled to a vessel and configured to provide forward scanning sonar data for imaging an underwater environment in a forward direction toward a bow of the vessel and below a surface of a body of water in which the vessel is deployed. The actions may include receiving rearward scanning sonar data from an aft sonar transducer coupled to the vessel and configured to provide rearward scanning sonar data for imaging the underwater environment in a rearward direction toward a stern of the vessel and below the surface of the body of water in which the vessel is deployed. The actions may include processing the forward and rearward scanning sonar data, and displaying images associated with the forward and rearward scanning sonar data on a split screen of the display.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Moreover, the claimed subject matter is not limited to implementations that solve any or all disadvantages noted in any part of this disclosure.

### BRIEF DESCRIPTION OF THE DRAWINGS

Implementations of various techniques are described herein with reference to the accompanying drawings. It should be understood, however, that the accompanying drawings illustrate only the various implementations described herein and are not meant to limit the scope of various techniques described herein.

FIGS. 1A-1B illustrate views of using sonar transducers in accordance with various implementations described herein.

FIGS. 2A-2C illustrate diagrams of transducer systems in accordance with various implementations described herein.

FIGS. 3-4 illustrate process flows of methods for using sonar transducers in accordance with various implementations described herein.

FIG. 5 illustrates a schematic of a marine electronics device in accordance with various implementations described herein.

### DETAILED DESCRIPTION

Various implementations described herein are directed to forward and rear scanning sonar. In one implementation, various techniques described herein refer to using sonar scanning technology to work simultaneously in both forward and rearward directions via multiple transducers. For instance, a forward facing transducer may be used to indicate where fish are located in a water column before a vessel maneuvers near the fish, while the rear facing transducer may be used to indicate where trolling lures are located in the water column. This technique may provide an angler a view and depth of the fish in the water column for adjusting the location and depth of their lures before moving through an area where the fish are holding.

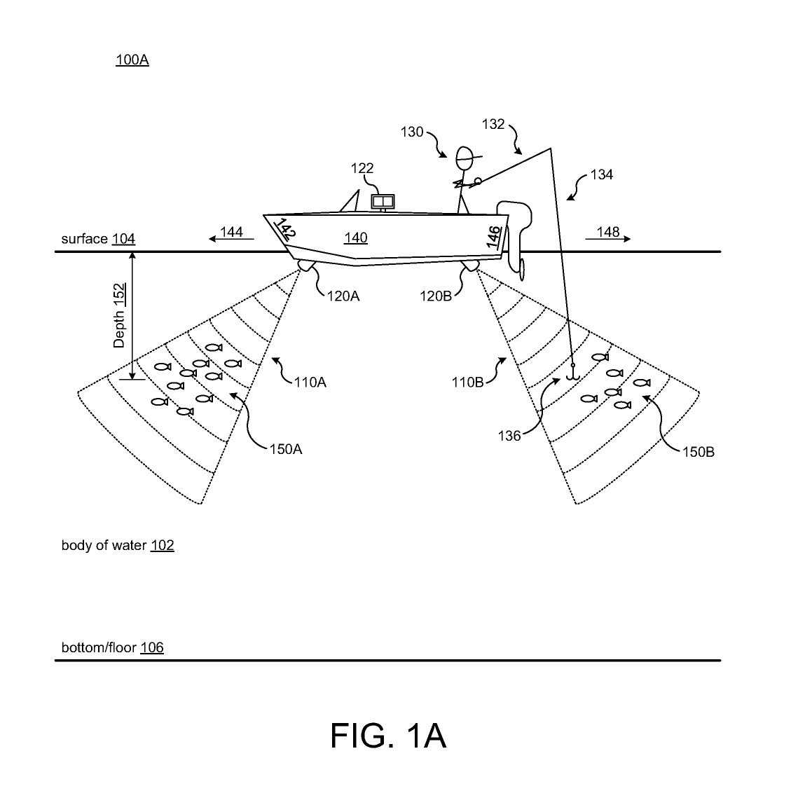

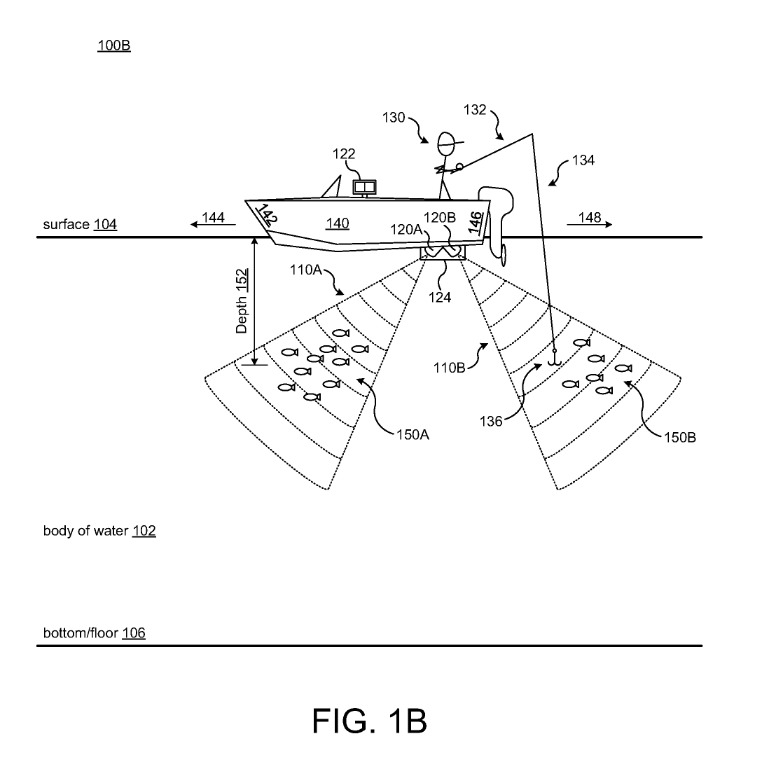

Various implementations of using forward and rear scanning sonar will now be described in reference to FIGS. 1A-5.

FIGS. 1A-1B illustrate views of using sonar transducers in accordance with various implementations described herein. In particular, FIG. 1A illustrates a view of a system 100A for using multiple sonar transducers, including a forward facing sonar transducer 120A and a rear facing sonar transducer 120B, and FIG. 1B illustrates a view of another system 100B for using an array of the multiple sonar transducers 120A, 120B incorporated, e.g., in a transducer device 124.

In reference to FIGS. 1A-1B, a first sonar beam 110A may be generated by a first transducer, which may include the forward facing sonar transducer 120A, and a second sonar beam 110B may be generated by a second transducer, which may include the rear facing sonar transducer 120B. The forward facing transducer 120A may be configured for imaging an underwater environment in a forward (fore) direction 144 relative to a bow 142 of a vessel 140 (e.g., watercraft, boat, ship, etc.) and below a surface 104 of a body of water 102 in which the vessel 140 is deployed. The rear facing transducer 120B may be configured for imaging the underwater environment in a rear(aft) direction 148 relative to a stern 146 of the vessel 140 and below the surface 104 of the body of water 102 in which the vessel 140 is deployed.

In some implementations, the first and second transducers 110A, 110B may be configured to provide various angular ranges of view in multiple directions, such as, e.g., approximately a 90° vertical view along with approximately a 15° to 30° horizontal view. In some instances, the various angular ranges of view may include or at least be extended to include angular ranges of vertical views from/between 0° to more than 90° along with angular ranges of horizontal views from/between 0° to 180°. In some other implementations, each of the first and second transducers 110A, 110B may be configured to manually or automatically rotate vertically and/or horizontally so as to rotate the view.

As shown in FIG. 1A, each of the forward facing transducer 120A and the rear facing transducer 120B may be separately coupled or mounted to a different part or portion of the vessel 140. Further, the forward facing transducer 120A may be located or positioned at a different spot on the vessel 140 and facing in a different direction than the rear facing transducer 120B. For instance, the forward facing transducer 120A may be coupled to the bow 142 of the vessel 140 and pointed (i.e., looking or facing) in the forward direction 144 (i.e., in a fore direction toward the bow 142 of the vessel 140), and the rear facing transducer 120B may be coupled to the stern 146 of the vessel 140 and pointed (i.e., looking or facing) in the rear direction 148 (i.e., in a rearward or an aft direction toward the stern 146 of the vessel 140).

During operation, the forward and rear facing transducers 120A, 120B may be configured to use sonar for imaging various environmental features (e.g., fish, plants, rocks, lures, bait, etc.) in the body of water 102. This imaging may include mapping an underwater environment below the surface 104 of the body of water 102 between the surface 104 and a bottom or floor 106 of the body of water 102. For instance, this imaging may include various images of fish or schools of fish 150A captured beneath the vessel 140 by the forward facing transducer 120A in the forward direction 144 with the first beam 110A. In another instance, this imaging may include various images of fish or schools of fish 150B captured beneath the vessel 140 by the rear facing transducer 120A in the rear direction 148 with the second beam 110B.

Generally, the term sonar (i.e., SOund Navigation And Ranging) refers to various techniques for propagating sound underwater to detect objects on or under a surface of a body of water, such as fish, lures, plants, rocks, sea floor, etc. One type of sonar technology refers to active sonar that is configured to emit pulses of sound waves while receiving echoes, which refers to pinging. Sonar may be used to determine acoustic locations and/or measurements of echo characteristics for targets and objects in a body of water. Further, acoustic frequencies used in sonar based devices may vary from low frequency (i.e., infrasonic) to high frequency (i.e., ultrasonic).

In reference to FIG. 1A, a computing device 122 may be coupled to the vessel 140 and used to display images associated with the forward facing transducer 120A and the rear facing transducer 120B. The computing device 122 may include one or more processing components (e.g., a processor) and memory including instructions configured to cause the one or more processing components to perform various actions and/or functions including display images associated with the forward facing transducer 120A and the rear facing transducer 120B. The computing device 122 may include various types of computing devices, such as, e.g., a marine electronics device, a multi-function display (MFD), a smart phone, etc. In some implementations, the computing device 122 may be configured to simultaneously display images associated with the forward facing transducer 120A and the rear facing transducer 120B in various display modes of operation, including, e.g., a split screen mode of operation, such as, a left-side display of the forward facing images and a right-side display of the rear facing images, which is described further herein.

During trolling, the fore or forward facing transducer 120A may be used to locate and/or track fish 150A in the body of water 102 beneath the vessel 140 at various depths 152 proximate to the bow 142 of the vessel 140. Further, during trolling, the aft or rearward facing transducer 120B may be used to locate and/or track fish 150B in the body of water 102 beneath the vessel 140 at the various depths 152 proximate to the stern 146 of the vessel 140. In some implementations, once the depth 152 of the fish is determined at the bow 142 of the vessel 140, then the same depth 152 may be used at the stern 146 of the vessel to drop a lure or bait 136 in the body of water 102 at the determined depth 152. For instance, during trolling, the lure or bait 136 may be coupled to a casting device, such as a rod 132 (e.g., a fishing rod or pole), via a line 134 (e.g., a fishing line). The rod 132 may be configured for casting the lure or bait 136 by the user 130. As shown in FIG. 1A, the user 130 may cast the lure or bait 136 into the body of water 102 proximate to the stern 146 of the vessel 140, while the user 130 (e.g., boat pilot, fisherman, angler, etc.) is positioned within the vessel 140 that is positioned in the body of water 102. In some implementations, fish 150A may be located and/or tracked with the fore or forward facing transducer 120A near the bow 142 of the vessel 140, and fish 150B and the bait or lure 136 may be located and/or tracked with the aft or rearward facing transducer 120B near the stern 146 of the vessel 140, or vice versa.

In reference to FIG. 1B, the forward facing transducer 120A and the rear facing transducer 120B may be combined and/or incorporated into a single device or as part of a transducer array, such as the transducer device or array 124, which is coupled or mounted to the vessel 140. As shown in FIG. 1B, the forward facing transducer 120A may be pointed (i.e., looking or facing) in the forward direction 144 (i.e., in the fore direction toward the bow 142 of the vessel 140), and the rear facing transducer 120B may be pointed (i.e., looking or facing) in the rear direction 148 (i.e., in the rearward or aft direction toward the stern 146 of the vessel 140).

During operation, the forward and rear facing transducers 120A, 120B of the transducer device 124 may be configured for imaging various environmental features (e.g., fish, plants, rocks, lures, bait, etc.) in the body of water 102 beneath the vessel 140 in the fore and aft directions 144, 148. As previously described, this imaging may include mapping the underwater environment between the surface 104 and the bottom or floor 106 of the body of water 102. This imaging may include images of fish 150A captured beneath the vessel 140 by the forward facing transducer 120A in the fore direction 144 with the first beam 110A. This imaging may also include images of other fish 150B captured beneath the vessel 140 by the rear facing transducer 120A in the aft direction 148 with the second beam 110B. Further, this imaging may include fore and aft images of water columns having the fish 150A, 150B. As described herein, these fore and aft images may be simultaneously displayed on the computing device 122 (e.g., MFD) with various display modes of operation, such as, e.g., a split screen mode of display, such as, e.g., a left-side display of the forward (fore) images and a right-side display of the rear or rearward (aft) images.

In various implementations, in reference to FIGS. 1A and 1B, the forward facing (fore facing) transducer 120A may be referred to as a forward scanning sonar transducer including a forward spotlight scan transducer, and the rear facing (aft facing) transducer 120B may be referred to as a rear scanning sonar transducer including a rear spotlight scan transducer. In some other implementations, each of the transducers 120A, 120B may include an array of multiple sonar transducers including, e.g., one or more of a right forward scanning element, a left forward scanning element, a conical sonar element, and a bar downscan sonar element. In this instance, the multiple sonar scanning elements are each capable of generating a separate sonar beam, wherein each sonar beam may include one or more of a conical beam projection and a linear beam projection. Further, in some instances, each of the sonar beams may include a conical downscan beam projection having a coverage area of a beam produced by a circular downscan transducer. Still further, in some other instances, each of the sonar beams may include a linear downscan beam projection having a coverage area of a beam produced by a linear downscan transducer.

In various implementations, each sonar transducer element (including sonar scanning elements) may be configured to use sonar technology to evaluate attributes of various target objects by interpreting echoes from sound waves. Further, each sonar transducer element may be configured to actively generate low and/or high frequency sound waves and evaluate reflected echoes to thereby measure time intervals between sending signals and receiving corresponding echoes to determine distance to target objects. Each sonar transducer element may be configured to convert energy into sound waves using piezoelectric transducers or capacitive transducers that are configured to convert electrical energy into sound. Each sonar transducer element may be configured to use piezoelectric crystals that include a property of changing size when voltage is applied, whereby applying an alternating current (AC) across the piezoelectric crystals may cause oscillations at high frequencies, to thereby generate high frequency sound waves. In some instances, focusing sound waves generated by each sonar transducer element may be determined by an area and shape of each sonar transducer element, a sound wave frequency of each sonar transducer element, and a sound velocity of the propagation medium, such as a body of water. In some instances, each sonar transducer element may use piezoelectric crystals configured as transceivers to transmit and detect sound waves in one or more elements, such as propagating sound waves and receiving echoing sound waves.

In some implementations, each of the forward and rear facing transducers 120A, 120B may be electrically coupled to the computing device 122 via one or more electrical wires or cables (not shown) passing through the vessel 140. The computing device 122 may be configured to record sonar data received from the transducers 120A, 120B via the electrical cables. Further, the computing device 122 may be configured to control operation of the vessel 140. In some instances, operation of the vessel 140 may be controlled by the computing device 122 including user interaction with the computing device 122. In some other instances, operation of the vessel 140 may be controlled via user interaction with a foot-pedal (not shown) positioned on the vessel 140.

In some implementations, the first and second transducers 120A, 120B may include one or more sensors (not shown). For instance, the one or more sensors may include a dedicated sensor (e.g., water sensor) configured for sensing deployment and/or removal of the first and second transducers 120A, 120B in and/or from the body of water 102. In this instance, the dedicated sensor may include electrode terminals (not shown) configured to activate (e.g., power-up) the transducers 120A, 120B when the vessel 140 is deployed in water. Further, the electrode terminals may be configured to deactivate (e.g., power-down) the transducers 120A, 120B when the vessel 140 is removed or withdrawn from water. The one or more sensors may include one or more environmental sensors, such as a temperature sensor.

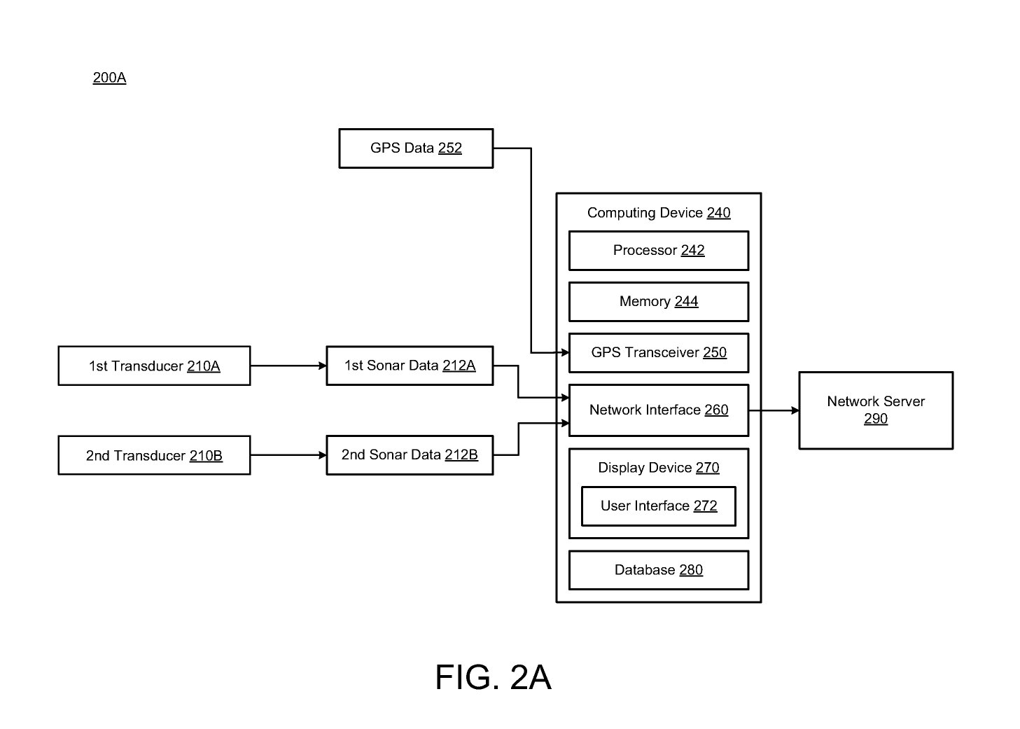

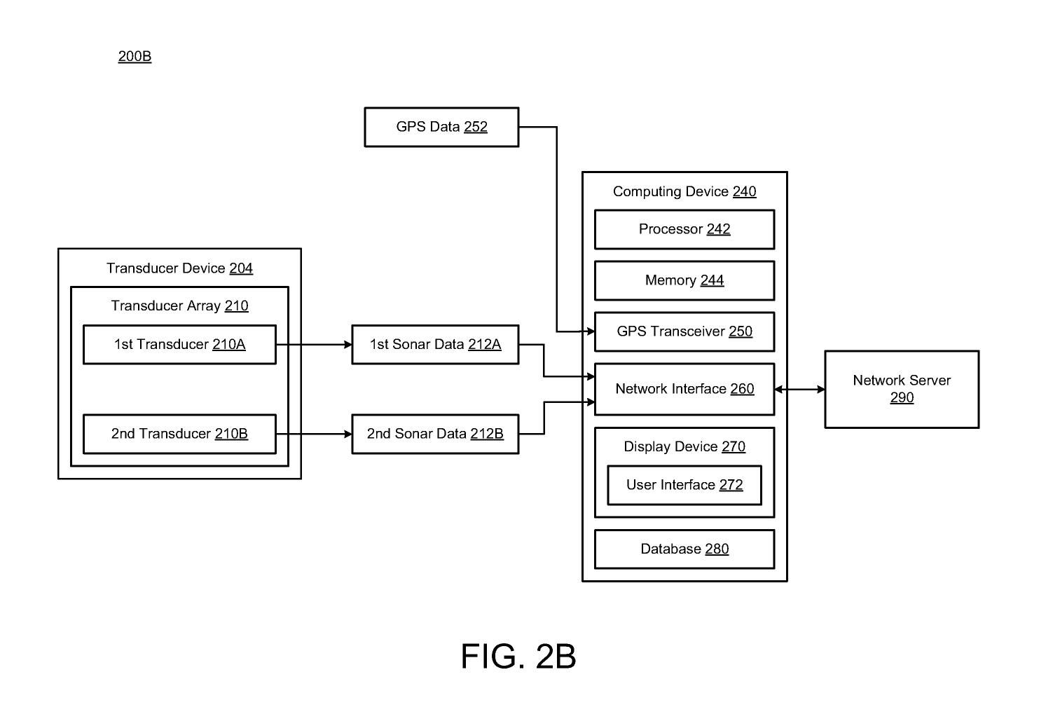

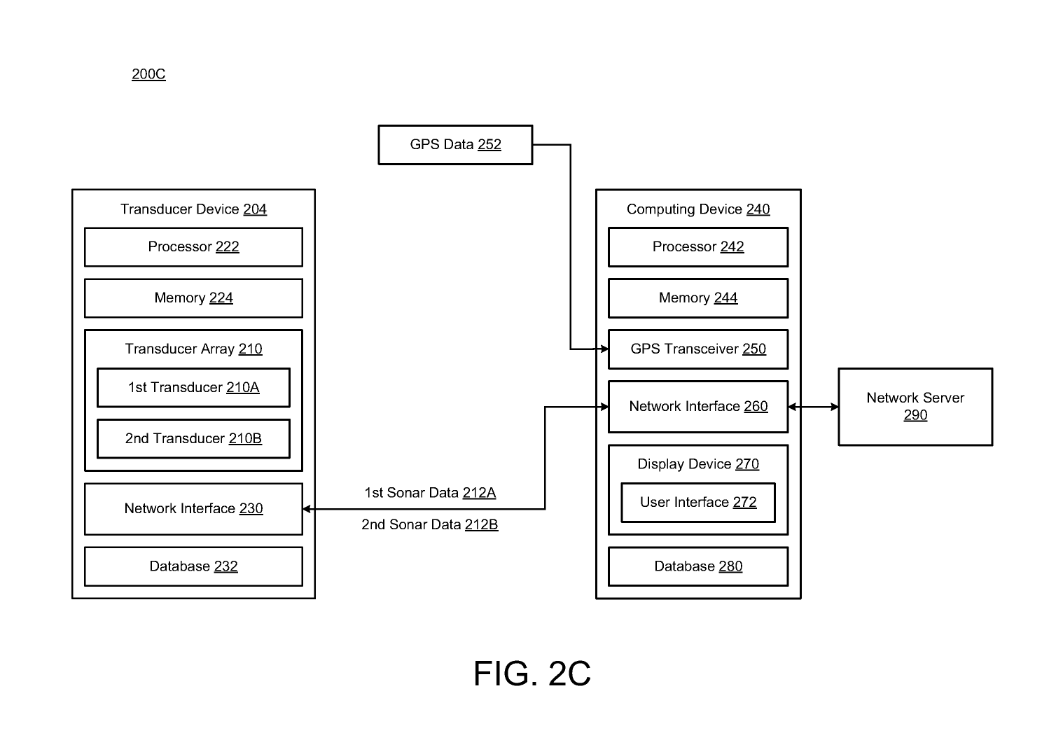

FIGS. 2A-2C illustrate diagrams of transducer systems in accordance with various implementations described herein. In particular, FIG. 2A illustrates a diagram of transducer system 200A using a first transducer 210A and a second transducer 210B, FIG. 2B illustrates another diagram of transducer system 200B using a transducer device 204 having a transducer array 210 with the first and second transducers 210A, 210B, and FIG. 2C illustrates another diagram of transducer system 200C using the transducer device 204 of FIG. 2B along with a processor 222 and memory 224.

In reference to FIG. 2A, the transducer system 200A may include the first transducer 210A, the second transducer 210B, a computing device 240, and a network server 290. The first transducer 210A may include a fore facing transducer configured to provide first sonar data 212A (e.g., forward scanning sonar data) corresponding to a bow of a vessel (e.g., facing toward a bow of a vessel), and the second transducer 210B may include an aft facing transducer configured to provide second sonar data 212B (e.g., rear or rearward scanning sonar data) corresponding to a stern of a vessel (e.g., facing toward a stern of a vessel).

In some implementations, the first transducer 210A may include a fore facing spotlight transducer array having multiple scanning transducers, and/or the second transducer 210B may include an aft facing spotlight transducer array having multiple scanning transducers. In some other implementations, the first and second transducers 210A, 210B may each include multiple transducer elements having one or more of a right scanning transducer, a left scanning transducer, a down scanning transducer, and a conical down beam transducer.

The first transducer 210A (e.g., fore facing transducer) may be configured to directly provide the first sonar data 212A (e.g., forward scanning sonar data) to the computing device 240. The second transducer 210B (e.g., aft facing transducer) may be configured to directly provide the second sonar data 212B (e.g., rear scanning sonar data) to the computing device 240. In some instances, the first and second transducers 210A, 210B may be configured to simultaneously provide the first and second sonar data 212A, 212B to the computing device 240 during a same time interval.

In some implementations, the computing device 240 may be configured to separately receive the first and second sonar data 212A, 212B from the first and second transducers 210A, 210B over a wired or wireless network via a network interface 260. In some other implementations, the computing device 240 may be configured to simultaneously receive the first and second sonar data 212A, 212B from the first and second transducers 210A, 210B over the wired or wireless network via the network interface 260.

The computing device 240 may include the processor 242 and memory 244 having instructions that cause the processor 242 to display images associated with the first sonar data 212A (e.g., forward scanning sonar data) and the second sonar data (e.g., rear scanning sonar data) on a display component or device 270. The instructions may cause the processor 242 to simultaneously display images associated with the first and second sonar data 212A, 212B on the display device 270 in a split screen mode of operation, such as, e.g., a left-side screen display of various images associated with the forward scanning sonar data (e.g., first sonar data 212A) and a right-side screen display of various images associated with the rear scanning sonar data (e.g., rear sonar data 212B). Further, the computing device 240 may be configured to create/generate sonar logs associated with the first and second sonar data 212A, 212B.

In some implementations, the computing device 240 may be configured to store/record sonar data 212A, 212B and/or sonar logs in one or more databases (e.g., database 280). The computing device 240 may be configured to upload the sonar data 212A, 212B and/or sonar logs to the network server 290, such as, e.g., a cloud server or other network server, via the network interface 260. The computing device 240 may be configured to store/record multiple sonar logs and create/generate a map therefrom. The computing device 240 and/or the network server 290 may be configured to create/generate one or more maps by stitching/combining/joining multiple sonar logs together. The computing device 220 may be configured to receive geo-coordinate data, such as global positioning system data (i.e., GPS data), via a GPS transceiver 250 and associate the received GPS data to the sonar data 212A, 212B, sonar logs, and/or maps at any time, including prior to upload. In various instances, the wired or wireless network may include any type of wired or wireless communication network and/or cloud based network.

In various implementations, the computing device 240 may be configured as a special purpose machine for interfacing with multiple transducers, such as, e.g., the first and second transducers 210A, 210B. The computing device 240 may include standard elements and/or components, including the at least one processor 242, the memory 244 (e.g., non-transitory computer-readable storage medium), at least one database 280, power, peripherals, and various other computing elements and/or components that may not be specifically shown in FIG. 2A. Further, the computing device 240 may include a display device 270 (e.g., a monitor or other display) that may be used to provide a user interface (UI) 272, including a graphical user interface (GUI). In FIG. 2A, the display 270 is shown as an incorporated part of the computing device 304; however, the display 270 may be implemented as a separate component. Further, the UI 272 may be used to receive one or more preferences from a user of the display device 270 for managing or utilizing the system 200A, including interfacing with the first and second transducers 210A, 210B. As such, a user may setup desired behavior of the computing system 200A and/or transducers 210A, 210B via user-selected preferences using the UI 272 associated with the display device 270. Various elements and/or components of the system 200A that may be useful for the purpose of implementing the system 200A may be added, included, and/or interchanged, in manner as described herein.

In reference to FIG. 2B, the transducer system 200B may include use of the transducer device 204 having the transducer array 210 along with the first and second transducers 210A, 210B. FIG. 2B may include various similar elements as shown and described in reference to FIG. 2A.

In some implementations, the transducer device 204 may include a housing that encapsulates the transducer array 210, in manner, e.g., as shown in reference to FIG. 1B. In this instance, the transducer array 210 may include multiple transducers, such as, e.g., the first and second transducers 210A, 210B. The first transducer 210A of the transducer array 210 may include a fore (forward) facing transducer configured to provide the first sonar data 212A (e.g., forward scanning sonar data) corresponding to a bow of a vessel (e.g., facing toward a bow of a vessel), and the second transducer 210B of the transducer array 210 may include an aft (rearward) facing transducer configured to provide the second sonar data 212B (e.g., rear or rearward scanning sonar data) corresponding to a stern of a vessel (e.g., facing toward a stern of a vessel).

In various implementations, referring to FIG. 2B, the computing device 240 may be configured as a special purpose machine for interfacing with the transducer array 210. Further, the computing device 204 may include standard elements and/or components, including the at least one processor 242, the memory 244, at least one database 280, power, peripherals (such as, e.g., display device 270 with UI 272), and various other computing elements and/or components that may not be specifically shown in FIG. 2B. Still further, the computing device 240 may include various other similar elements as shown and described in reference to FIG. 2A.

In reference to FIG. 2C, the transducer system 200C may include use of the transducer device 204 having the transducer array 210 along with the first and second transducers 210A, 210B. FIG. 2C may include various similar elements as shown and described in reference to FIGS. 2A and 2B.

In some implementations, the transducer device 204 may include a housing that encapsulates the transducer array 210, in manner, e.g., as shown in reference to FIG. 1B. In this instance, the transducer array 210 may include multiple transducers, such as, e.g., the first and second transducers 210A, 210B. Further, the housing of the transducer device 204 may be configured to encapsulate a computing device (e.g., at least one processor 222), memory 224 (e.g., a non-transitory computer-readable storage medium), a network interface 230, at least one database 232, power, peripherals, and various other computing elements and/or components that may not be specifically shown in FIG. 2C. The network interface 230 may be configured to simultaneously provide the forward scanning sonar data 212A and the rear scanning sonar data 212B to the computing device 240 via a wired or wireless network. Thus, in this instance, the network interface 230 of the transducer device 204 may be configured to communicate with the network interface 260 of the computing device 240 via the wired or wireless network. Further, in some instances, the memory 224 of the transducer device 204 may include instructions that cause the processor 222 to simultaneously provide the forward and rear scanning sonar data 212A, 212B to the computing device 240 over the wired or wireless network via the network interfaces 230, 260.

In various implementations, referring to FIG. 2C, the computing device 240 may be configured as a special purpose machine for interfacing with the transducer array 210 having multiple transducers, such as, e.g., the first and second transducers 210A, 210B. Further, the computing device 204 may include standard elements and/or components, including the at least one processor 242, the memory 244, at least one database 280, power, peripherals (such as, e.g., display device 270 with UI 272), and various other computing elements and/or components that may not be specifically shown in FIG. 2B. Still further, the computing device 240 may include various other similar elements as shown and described in reference to FIGS. 2A and 2B.

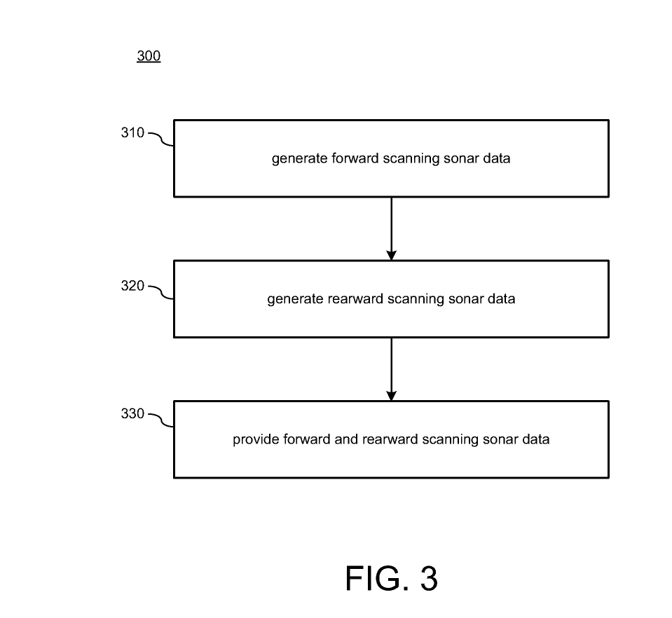

FIG. 3 illustrates a process flow diagram for a method 300 of using and/or operating sonar transducers in accordance with implementations of various techniques described herein. It should be understood that while method 300 indicates a particular order of execution of operations, in some instances, certain portions of the operations may be executed in a different order, and on different systems. Further, in some other instances, additional operations or steps may be added to method 300. Similarly, some operations or steps may be omitted.

At block 310, method 300 may generate forward scanning sonar data. For instance, a fore facing transducer may be used to generate forward scanning sonar data corresponding to, e.g., a bow of a vessel. The fore facing transducer may be configured for imaging an underwater environment in a forward direction relative to a bow of a vessel and below a surface of a body of water in which the vessel is deployed.

At block 320, method 300 may generate rearward scanning sonar data. For instance, an aft facing transducer may be used to generate rearward scanning sonar data corresponding to, e.g., a stern of a vessel. In some implementations, the fore facing and aft facing transducers may be configured to simultaneously provide the forward and rearward scanning sonar data during a same time interval. The aft facing transducer may be configured for imaging an underwater environment in a rearward direction relative to a stern of a vessel and below a surface of a body of water in which the vessel is deployed.

At block 330, method 300 may provide the forward and rearward scanning data. For instance, the fore facing and aft facing transducers may be used to provide the forward and rearward scanning sonar data to a computing component via a wired or wireless network. The computing component may include, e.g., a computing device, a marine electronics device, a multi-function display, a computer, a remote computer, a smart phone, a server, a remote server, etc.

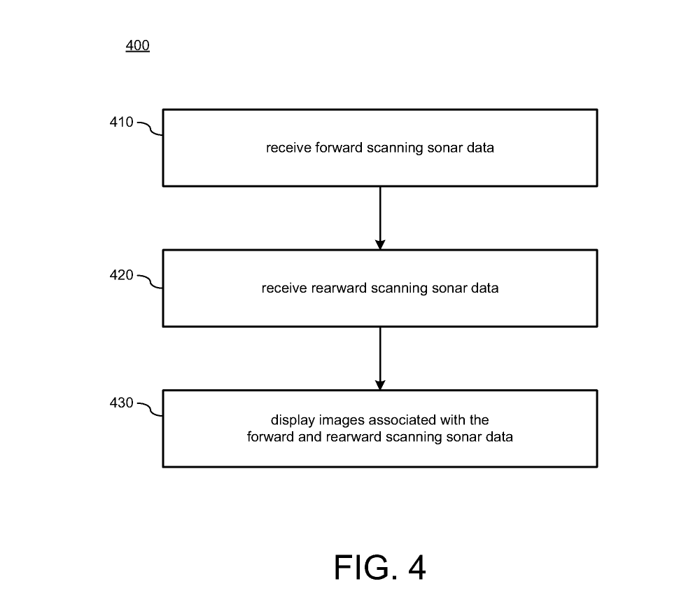

FIG. 4 illustrates a process flow diagram for a method 400 of using and/or operating sonar transducers in accordance with implementations of various techniques described herein. It should be understood that while method 400 indicates a particular order of execution of operations, in some instances, certain portions of the operations may be executed in a different order, and on different systems. Further, in some other instances, additional operations or steps may be added to method 400. Similarly, some operations or steps may be omitted.

In some implementations, method 400 may be implemented as an application on a computing device, such as, e.g., a marine electronics device or a multi-function display (MFD). In other implementations, method 400 may be performed by any type of computer component, device, or system, such as, e.g., a portable computer system, a smart phone device, a remote server, a network server, a cloud server, and the like.

At block 410, method 400 may receive forward scanning sonar data. For instance, a computing device may be configured to receive and process sonar data, including forward scanning sonar data from a fore facing transducer coupled or mounted to a vessel. In some instances, the fore facing transducer may be coupled or mounted to or near a bow of a vessel. In some other instances, the fore facing transducer may be coupled or mounted to any part of a vessel and pointed (i.e., looking or facing) in a direction toward a bow of a vessel. As such, in various implementations, the fore facing transducer may be configured for imaging an underwater environment in a forward (fore) direction relative to facing toward a bow of a vessel and below a surface of a body of water in which the vessel is deployed.

At block 420, method 400 may receive rearward scanning sonar data. For instance, a computing device may be configured to receive and process sonar data, including rearward scanning sonar data from an aft facing transducer coupled or mounted to a vessel. In some instances, the aft facing transducer may be coupled or mounted to or near a stern of a vessel. In some other instances, the aft facing transducer may be coupled or mounted to any part of a vessel and pointed (i.e., looking or facing) in a direction toward a stern of a vessel. As such, in some implementations, the aft facing transducer may be configured for imaging an underwater environment in a rearward (aft) direction relative to facing toward astern of a vessel and below a surface of a body of water in which the vessel is deployed.

At block 430, method 400 may display images associated with the forward and rearward scanning data. For instance, the computing device may be configured to simultaneously display images associated with the forward (fore) and rearward (aft) scanning sonar data on a display component or device. In some other instances, the computing device may be configured to simultaneously display images associated with the forward and rearward scanning sonar data in a split screen mode of operation, such as, e.g., a left-side display of the forward facing images and a right-side display of the rear facing images, or vice versa.

### Computing System

Implementations of various technologies described herein may be operational with numerous general purpose or special purpose computing system environments or configurations. Instances of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. The computing systems may be configured to operate using various radio frequency technologies and implementations, such as sonar, radar, GPS, and like technologies.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

### Marine Electronics Device

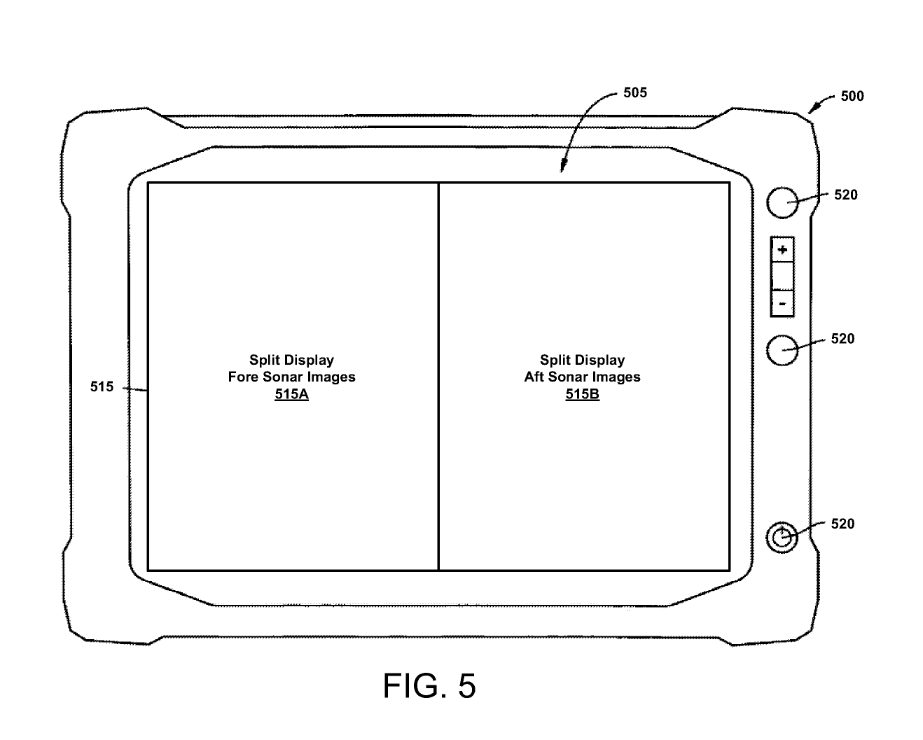

FIG. 5 illustrates an instance schematic of a marine electronics device 500 in accordance with implementations of various techniques described herein. The marine electronics device 500 includes a screen 505. In some instances, the screen 505 may be sensitive to touching by a finger. In other instances, the screen 505 may be sensitive to the body heat from the finger, a stylus, or responsive to a mouse. In various implementations, the marine electronics device 500 may be attached to various buses and/or networks, such as, e.g., a National Marine Electronics Association (NMEA) bus or network. The marine electronics device 500 may send or receive data to or from another device attached to the NMEA 2000 bus. For instance, the marine electronics device 500 may transmit commands and receive data from a motor or a sensor using an NMEA 2000 bus. In some implementations, the marine electronics device 500 may be capable of steering a vessel and controlling the speed of the vessel, i.e., autopilot. For instance, one or more waypoints may be input to the marine electronics device 500, and the marine electronics device 500 may be configured to steer the vessel to the one or more waypoints. Further, the marine electronics device 500 may be configured to transmit and/or receive NMEA 2000 compliant messages, messages in a proprietary format that do not interfere with NMEA 2000 compliant messages or devices, and/or messages in any other format. In various other implementations, the marine electronics device 400 may be attached to various other communication buses and/or networks configured to use various other types of protocols that may be accessed via, e.g., NMEA 2000, NMEA 0183, Ethernet, Proprietary wired protocol, etc.

The marine electronics device 500 may be operational with numerous general purpose or special purpose computing system environments and/or configurations. The marine electronics device 500 may include any type of electrical and/or electronics device capable of processing data and information via a computing system. The marine electronics device 500 may include various marine instruments, such that the marine electronics device 500 may use the computing system to display and/or process the one or more types of marine electronics data. The device 500 may display marine electronic data 515, such as, e.g., sonar data and images associated with sonar data. The marine electronic data types 515 may include chart data, radar data, sonar data, steering data, dashboard data, navigation data, fishing data, engine data, and the like. The marine electronics device 500 may include a plurality of buttons 520, which may be include physical buttons or virtual buttons, or a combination thereof. The marine electronics device 500 may receive input through a screen 505 sensitive to touch or buttons 520.

In some implementations, according to various techniques described herein, the marine electronics device 500 may be configured to simultaneously display images associated with multiple transducers, array of transducers, and the like. For instance, the marine electronics device 500 may be configured to simultaneously display images associated with a plurality of transducers, including a first transducer, such as, e.g., the forward (fore) facing transducer 120A, and a second transducer, such as, e.g., the rear (aft) facing transducer 120B. In some instances, in various display modes of operation, the marine electronics device 500 may be configured to simultaneously display images associated with sonar data on the screen 505. For instance, the marine electronics device 500 may be configured to simultaneously display images associated with sonar data from multiple points of view on the screen 505, e.g., in a split screen mode of operation, such as, e.g., a left-side display 515A of forward (fore) facing sonar images and a right-side display 515B of rear (aft) facing images.

The marine electronics device 500 may be configured as a computing system having a central processing unit (CPU), a system memory, a graphics processing unit (GPU), and a system bus that couples various system components including the system memory to the CPU. In various implementations, the computing system may include one or more CPUs, which may include a microprocessor, a microcontroller, a processor, a programmable integrated circuit, or a combination thereof. The CPU may include an off-the-shelf processor such as a Reduced Instruction Set Computer (RISC), or a Microprocessor without Interlocked Pipeline Stages (MIPS) processor, or a combination thereof. The CPU may also include a proprietary processor.

The GPU may be a microprocessor specifically designed to manipulate and implement computer graphics. The CPU may offload work to the GPU. The GPU may have its own graphics memory, and/or may have access to a portion of the system memory. As with the CPU, the GPU may include one or more processing units, and each processing unit may include one or more cores.

The CPU may provide output data to a GPU. The GPU may generate graphical user interfaces that present the output data. The GPU may also provide objects, such as menus, in the graphical user interface. A user may provide inputs by interacting with the objects. The GPU may receive the inputs from interaction with the objects and provide the inputs to the CPU. A video adapter may be provided to convert graphical data into signals for a monitor (MFD 500).

The system bus may be any of several types of bus structures, including a memory bus or memory controller, a peripheral bus, and a local bus using any of a variety of bus architectures. By way of instance, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory may include a read only memory (ROM) and a random access memory (RAM). A basic input/output system (BIOS), containing the basic routines that help transfer information between elements within the computing system, such as during start-up, may be stored in the ROM.

The computing system may further include a hard disk drive interface for reading from and writing to a hard disk, a memory card reader for reading from and writing to a removable memory card, and an optical disk drive for reading from and writing to a removable optical disk, such as a CD ROM or other optical media. The hard disk, the memory card reader, and the optical disk drive may be connected to the system bus by a hard disk drive interface, a memory card reader interface, and an optical drive interface, respectively. The drives and their associated computer-readable media may provide nonvolatile storage of computer-readable instructions, data structures, program modules and other data for the computing system.

Although the computing system is described herein as having a hard disk, a removable memory card and a removable optical disk, it should be appreciated by those skilled in the art that the computing system may also include other types of computer-readable media that may be accessed by a computer. For instance, such computer-readable media may include computer storage media and communication media. Computer storage media may include volatile and non-volatile, and removable and non-removable media implemented in any method or technology for storage of information, such as computer-readable instructions, data structures, program modules, software modules, or other data. Computer-readable storage media may include non-transitory computer-readable storage media. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of instance, and not limitation, communication media may include wired media such as a wired network or direct-wired connection, and wireless media such as acoustic, radio frequency (RF), infrared (IR), and other wireless media. The computing system may include a host adapter that connects to a storage device via a small computer system interface (SCSI) bus, Fiber Channel bus, eSATA bus, or using any other applicable computer bus interface.

The computing system can also be connected to a router to establish a wide area network (WAN) with one or more remote computers. The router may be connected to the system bus via a network interface. The remote computers can also include hard disks that store application programs. In another implementation, the computing system may also connect to the remote computers via local area network (LAN) or the WAN. When using a LAN networking environment, the computing system may be connected to the LAN through the network interface or adapter. The LAN may be implemented via a wired connection or a wireless connection. The LAN may be implemented using Wi-Fi™ technology, cellular technology, Bluetooth™ technology, satellite technology, or any other implementation known to those skilled in the art. The network interface may also utilize remote access technologies (e.g., Remote Access Service (RAS), Virtual Private Networking (VPN), Secure Socket Layer (SSL), Layer 2 Tunneling (L2T), or any other suitable protocol). In some instances, these remote access technologies may be implemented in connection with the remote computers. It will be appreciated that the network connections shown are exemplary and other means of establishing a communications link between the computer systems may be used.

A number of program modules may be stored on the hard disk, memory card, optical disk, ROM or RAM, including an operating system, one or more application programs, and program data. In certain implementations, the hard disk may store a database system. The database system could include, for instance, recorded points. The application programs may include various mobile applications (“apps”) and other applications configured to perform various methods and techniques described herein. The operating system may be any suitable operating system that may control the operation of a networked personal or server computer.

As described herein, a user may enter commands and information into the computing system through input devices such as the buttons 520, which may be physical buttons, virtual buttons, or combinations thereof. In some implementations, other input devices may be used and may include a microphone, a mouse, or the like (not shown). These and other input devices may be connected to the CPU through a serial port interface coupled to system bus, but may be connected by other interfaces, such as a parallel port, game port or a universal serial bus (USB).

Certain implementations may be configured to be connected to a global positioning system (GPS) receiver system and/or a marine electronics system. The GPS system and/or marine electronics system may be connected via the network interface. The GPS receiver system may be used to determine position data for the vessel on which the marine electronics device 500 is disposed. The GPS receiver system may then transmit the position data to the marine electronics device 500. In other instances, any positioning system known to those skilled in the art may be used to determine and/or provide the position data for the marine electronics device 500.

The marine electronics system may include one or more components disposed at various locations on the vessel. Such components may include one or more data modules, sensors, instrumentation, and/or any other devices known to those skilled in the art that may transmit various types of data to the marine electronics device 500 for processing and/or display. The various types of data transmitted to the marine electronics device 500 from the marine electronics system may include marine electronics data and/or other data types known to those skilled in the art. The marine electronics data received from the marine electronics system may include chart data, sonar data, structure data, radar data, navigation data, position data, heading data, automatic identification system (AIS) data, Doppler data, speed data, course data, or any other type known to those skilled in the art.

In one implementation, the marine electronics system may include a radar sensor for recording the radar data and/or the Doppler data, a compass heading sensor for recording the heading data, and a position sensor for recording the position data. In a further implementation, the marine electronics system may include an AIS transponder for recording the AIS data, a paddlewheel sensor for recording the speed data, and/or the like.

The marine electronics device 500 may receive external data via the LAN or the WAN. In one implementation, the external data may relate to information not available from the marine electronics system. The external data may be retrieved from the Internet or any other source. The external data may include atmospheric temperature, tidal data, weather, moon phase, sunrise, sunset, water levels, historic fishing data, and other fishing data.

In one implementation, the marine electronics device 500 may be a multi-function display (MFD) unit, such that the marine electronics device 500 may be capable of displaying and/or processing multiple types of marine electronics data. FIG. 5 illustrates a schematic diagram of an MFD unit in accordance with implementations of various techniques described herein. In particular, the MFD unit may include the computing system, the monitor (MFD 500), the screen 505, and the buttons such that they may be integrated into a single console.

The discussion of the present disclosure is directed to certain specific implementations. It should be understood that the discussion of the present disclosure is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of the implementations and combinations of elements of different implementations within the scope of the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort maybe complex and time consuming, but would nevertheless be a routine undertaking of design, fabrication, and manufacture for those of ordinary skill having benefit of this disclosure. Nothing in this application should be considered critical or essential to the claimed subject matter unless explicitly indicated as being “critical” or “essential.”

Reference has been made in detail to various implementations, instances of which are illustrated in the accompanying drawings and figures. In the following detailed description, numerous specific details are set forth to provide a thorough understanding of the present disclosure. However, the present disclosure may be practiced without these specific details. In other instances, well-known methods, procedures, components, circuits and networks have not been described in detail so as not to unnecessarily obscure aspects of the embodiments.

It should also be understood that, although the terms first, second, etc. may be used herein to describe various elements, these elements should not be limited by these terms. These terms are only used to distinguish one element from another. For instance, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations and is not intended to limit the present disclosure. As used in the description of the present disclosure and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,”“including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as instance forms of implementing the claims.

What is claimed is:

1. A system, comprising:
a fore facing transducer configured to provide forward scanning sonar data below a surface of a body of water and corresponding to a bow of a vessel; and
an aft facing transducer configured to provide rear scanning sonar data below the surface of the body of water and corresponding to a stern of the vessel.

2. The system of claim 1, wherein the forward scanning sonar data and the rear scanning sonar data are provided simultaneously during a same time interval.

3. The system of claim 1, wherein the fore facing transducer is configured for imaging an underwater environment in a forward direction relative to the bow of the vessel and below the surface of the body of water in which the system is deployed.

4. The system of claim 1, wherein the aft facing transducer is configured for imaging an underwater environment in a rearward direction relative to the stern of the vessel and below the surface of the body of water in which the system is deployed.

5. The system of claim 1, wherein the fore facing transducer comprises a fore facing spotlight transducer array having multiple scanning transducers.

6. The system of claim 1, wherein the fore facing transducer comprises multiple transducer elements having one or more of a right scanning transducer, a left scanning transducer, a down scanning transducer, and a conical down beam transducer.

7. The system of claim 1, wherein the aft facing transducer comprises an aft facing spotlight transducer array having multiple scanning transducers.

8. The system of claim 1, wherein the aft facing transducer comprises multiple transducer elements having one or more of a right scanning transducer, a left scanning transducer, a down scanning transducer, and a conical down beam transducer.

9. A system, comprising:
a plurality of transducers coupled to a vessel, having:
a first transducer configured to provide fore scanning sonar data relative to a bow of the vessel, and
a second transducer configured to provide aft scanning sonar data relative to a stern of the vessel; and
a computing device configured to display images associated with the fore scanning sonar data and the aft scanning sonar data on a display.

10. The system of claim 9, wherein the plurality of transducers are incorporated as part of a transducer array coupled to a bottom of the vessel.

11. The system of claim 9, wherein the computing device is configured to simultaneously display images associated with the fore scanning sonar data and the aft scanning sonar data on the display.

12. The system of claim 9, wherein the computing device further comprises a network interface configured to receive the fore and aft scanning sonar data from the first and second transducers, respectively, via a wired or wireless network.

13. The system of claim 9, wherein each of the first and second transducers comprises a spotlight transducer array having multiple scanning transducers.

14. The system of claim 9, wherein each of the first and second transducers comprises multiple transducer elements having one or more of a right scanning transducer, a left scanning transducer, a down scanning transducer, and a conical down beam transducer.

15. A multi-function display, comprising:
a processor;
a display; and
memory having instructions that cause the processor to:
receive forward scanning sonar data from a fore sonar transducer coupled to a vessel and configured to provide forward scanning sonar data for imaging an underwater environment in a forward direction toward a bow of the vessel and below a surface of a body of water in which the vessel is deployed, and
receive rearward scanning sonar data from an aft sonar transducer coupled to the vessel and configured to provide rearward scanning sonar data for imaging the underwater environment in a rearward direction toward a stern of the vessel and below the surface of the body of water in which the vessel is deployed,
process the forward and rearward scanning sonar data, and
display images associated with the forward and rearward scanning sonar data on a split screen of the display.

16. The multi-function display of claim 15, wherein the fore sonar transducer is coupled to the vessel at a first position, and wherein the aft sonar transducer is coupled to the vessel at a second position that is different than the first position.

17. The multi-function display of claim 15, wherein the instructions cause the processor to simultaneously display images associated with the forward and rearward scanning sonar data on the split screen of the display.

18. The multi-function display of claim 15, wherein the computing device further comprises a network interface configured to receive the forward and rearward scanning sonar data from the fore and aft sonar transducers, respectively, via a wired or wireless network.

19. The multi-function display of claim 15, wherein each of the fore and aft sonar transducers comprise a spotlight transducer array having multiple scanning transducers.

20. The multi-function display of claim 15, wherein each of the fore and aft sonar transducers comprise multiple transducer elements having one or more of a right scanning transducer, a left scanning transducer, a down scanning transducer, and a conical down beam transducer.
